(19) United States
(12) Patent Application Publication
(10) Pub. No.: US 2025/0126205 A1
(43) Pub. Date: Apr. 17, 2025

(54) SYSTEMS AND METHODS FOR SERVICE CENTER CONTROL AND MANAGEMENT

(71) Applicant: VERIZON PATENT AND LICENSING INC., Basking Ridge, NJ (US)

(72) Inventors: Subham BISWAS, Thane (IN); Dheeraj SINGH, Hyderabad (IN); Miruna JAYAKRISHNASAMY, Vellore (IN); Prakash RANGANATHAN, Tamilnadu (IN)

(73) Assignee: VERIZON PATENT AND LICENSING INC., Basking Ridge, NJ (US)

(21) Appl. No.: 18/488,427

(22) Filed: Oct. 17, 2023

(51) Int. Cl. H04M 3/51; G06Q 10/0639; H04M 3/523

(52) U.S. Cl. CPC H04M 3/5175; G06Q 10/06398; H04M 3/523; H04M 2203/401; H04M 2203/551; H04M 2203/558

(57) ABSTRACT

Disclosed are systems and methods for a computerized framework enacted by service contact centers that provides a proactive and adaptive response system that accurately identifies security and/or legal concerns of service requests, and enables artificial intelligence/machine learning (AI/ML)-based mechanisms for dynamically addressing the underlying technical and/or service related concerns of such service requests. The disclosed framework can computationally determine how effective service agents have been, and are currently being in curating solutions/responses to each customer service call, which can enable modified functionality for the customer as well as curated services based on how sufficiently handled the service call was responded to by the agent. The disclosed systems and methods provide a generative service call experience that can improve agent performance while reducing the strain on user experience, both during and/or after service calls.

### BACKGROUND INFORMATION

Contact centers for service providers (e.g., Verizon®) are configured to provide interactive experiences for users (or customers, used interchangeably) to engage with service agents (or agents or representatives, used interchangeably). Such experiences can involve service requests related to service/device upgrades, troubleshooting, technical and/or billing inquiries, and the like, or some combination thereof.

### BRIEF DESCRIPTION OF THE DRAWINGS

The features and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example network architecture according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIGS. 4A-4B illustrate non-limiting example embodiments according to some embodiments of the present disclosure;

FIG. 5 illustrates a non-limiting example embodiment of a network architecture according to some embodiments of the present disclosure; and

FIG. 6 is a block diagram illustrating a computing device showing an example of a client or server device used in various embodiments of the present disclosure.

### DETAILED DESCRIPTION OF EXAMPLE EMBODIMENTS

Service requests (or service calls) typically involve a user contacting a service center through a designated communication channel, such as, for example, telephone, email, chat, a website form, and the like. The user can provide the necessary information related to their request (e.g., account number, order number, personal details, and the like), as well as the reasoning for the request (e.g., the intent—for example, troubleshoot an account, service, product and the like; upgrade service; and the like, as discussed infra). Based on the information gathered, the service agent can offer a solution, assistance and/or further steps to resolve the issue. For example, this may involve providing instructions, troubleshooting steps and/or scheduling a repair or service appointment. Once the issue is resolved or the user's needs are met, the service agent can confirm that the user is satisfied and close the service call. Agents may also provide relevant documentation or reference numbers for future inquiries.

Despite the apparent transparent nature of such interactions, the results of service calls may generally not be positive. That is, via conventional mechanisms, service requests can result in experiences that are not only insufficient in addressing the user's concerns/intent for their initiated service call, but also are contrary to such intent. For example, products or services may be added to a user's account without their consent (e.g., the user called to dispute a bill, and despite an apparent failed “up-sell” of the user signing up for Disney+®, such service/subscription was added to their account). In another non-limiting example, the user may not be provided all necessary details related to transactional level charges during the interaction with care teams; and, this can result in bill shock, user churn, bad customer experience and/or legal issues, and the like, or some combination thereof. Accordingly, negative experiences for customer service calls can reduce customer loyalty, stunt customer growth and reduce brand value of a company.

Accordingly, the disclosed systems and methods provide a computerized framework that provides innovative, technical solutions that can identify security concerns with a user's account, their activity and/or their interactions with a service agent, as well as provide capabilities for preventing any illegal and/or un-approved activity. For example, such activities can include, but are not limited to, “cramming”, “slamming”, Consumer Clear Disclosures (CCD), fraud events, and/or any other type of legal, regulatory and/or security compliance component for which service providers are expected to protect their customers. As discussed herein, the disclosed systems and methods can provide adaptive, deterministic functionality for service (or contact) call centers that can mitigate security and/or legal risks, while improving and promoting optimization in the mechanisms in which service requests are handled.

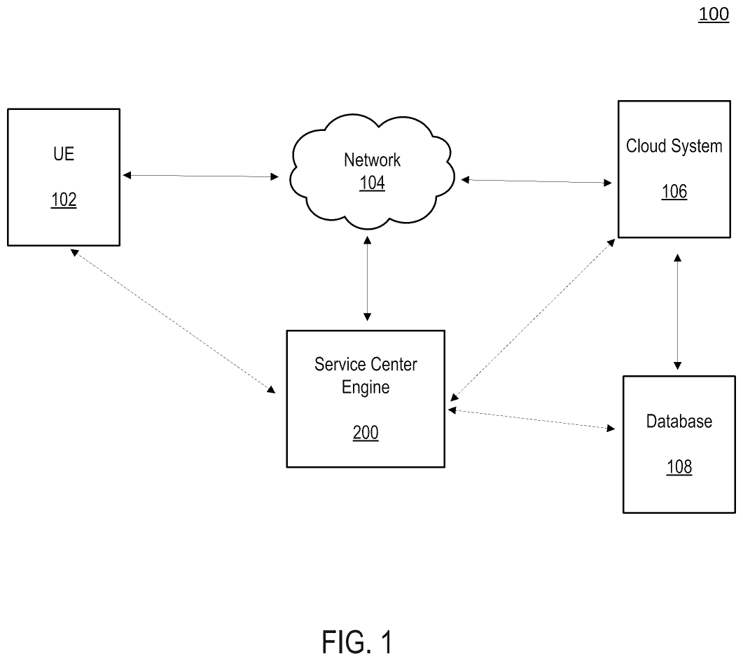

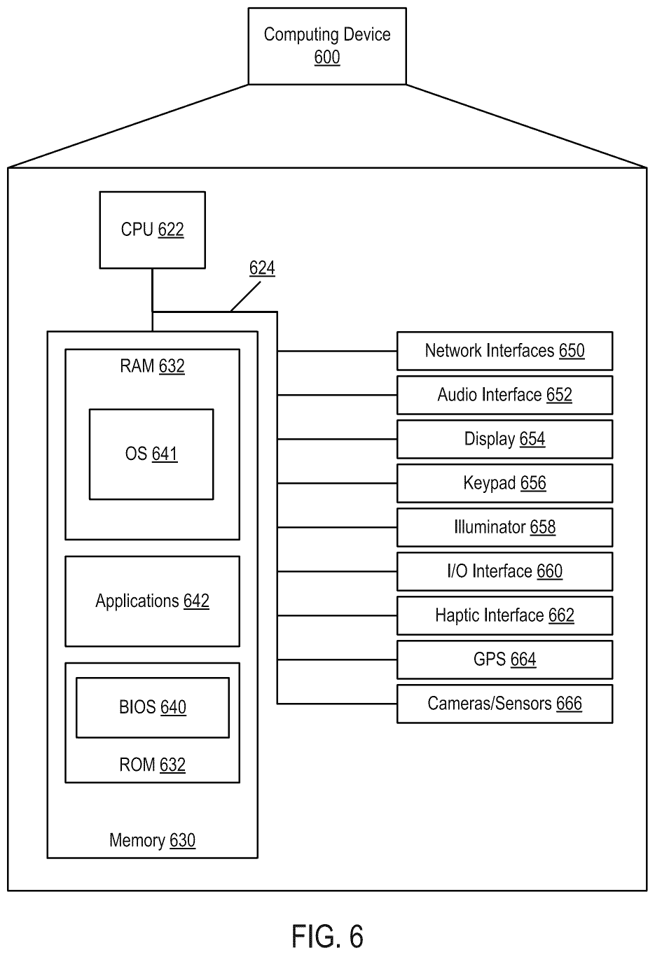

With reference to FIG. 1, system 100 is depicted which includes user equipment (UE) 102 (e.g., a client device, as mentioned above and discussed below in relation to FIG. 6), network 104, cloud system 106, database 108, and service center engine 200. It should be understood that while system 100 is depicted as including such components, it should not be construed as limiting, as one of ordinary skill in the art would readily understand that varying numbers of UEs, peripheral devices, cloud systems, databases and networks can be utilized; however, for purposes of explanation, system 100 is discussed in relation to the example depiction in FIG. 1.

According to some embodiments, UE 102 can be any type of device, such as, but not limited to, a mobile phone, tablet, laptop, game console, smart television (TV), Internet of Things (IoT) device, autonomous machine, wearable device, and/or any other device equipped with a cellular or wireless or wired transceiver. In some embodiments, as discussed below, UE 102 can correspond to a user device; and in some embodiments, UE 102 can correspond to a device of an agent associated with and/or operating a call center for a service provider.

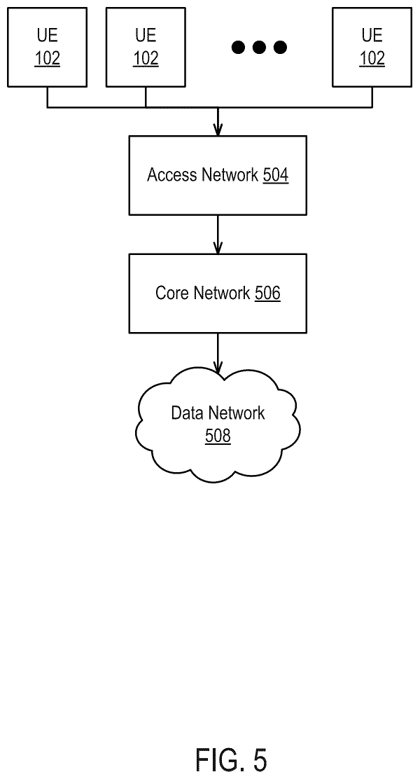

In some embodiments, network 104 can be any type of network, such as, but not limited to, a wireless network, cellular network, the Internet, and the like (as discussed above). Network 104 facilitates connectivity of the components of system 100, as illustrated in FIG. 1. Further discussion of embodiments of network 104 are provided below with reference to FIG. 5.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a cellular provider—Verizon®, which has associated network resources hosted on the internet or private network (e.g., network 104), which enables (via engine 200) the call/network management discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE 102 and the services and applications provided by cloud system 106 and/or service center engine 200).

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

According to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

According to some embodiments, as discussed below, database 108 can represent a plurality of databases and/or be partitioned into segments for particular data stores to host, store and provide capabilities for enabling access to information related to particular events, agents and/or customers, as discussed below. Thus, for example, a plurality of databases can be provided and represented by database 108, where a set of databases can be respectively provided for, but not limited to, events (e.g., service calls and/or results of such calls), agents and/or customers.

Service center engine 200, as discussed above and further below in more detail, can include components for the disclosed functionality. According to some embodiments, service center engine 200 may be a special purpose machine or processor, and can be hosted by a device on network 104, within cloud system 106 and/or on UE 102. In some embodiments, engine 200 may be hosted by a server and/or set of servers associated with cloud system 106.

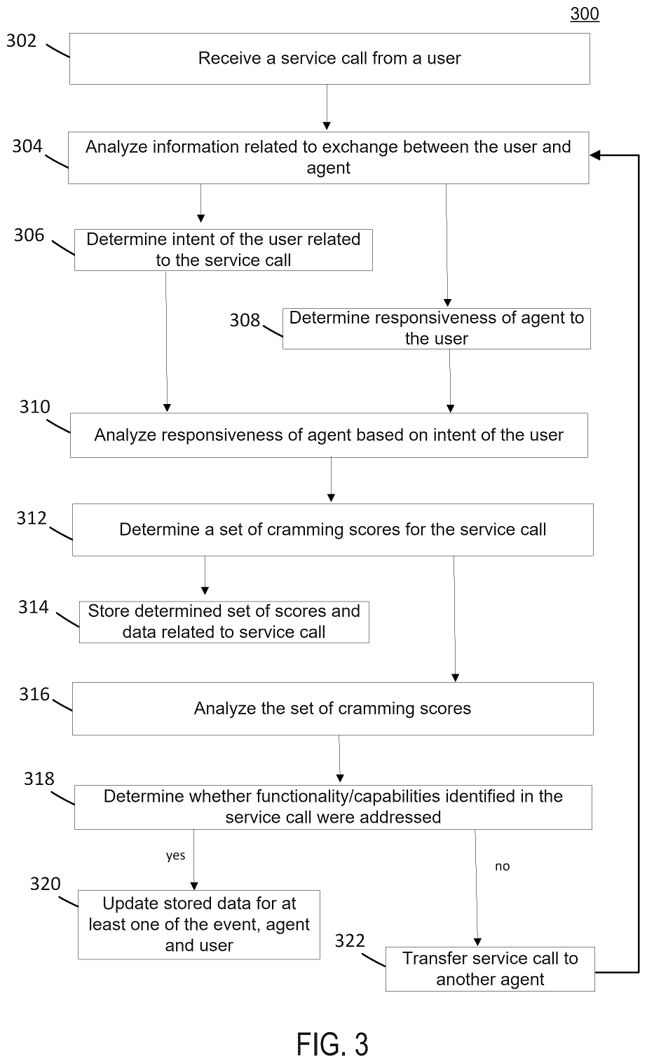

According to some embodiments, as discussed in more detail below, service center engine 200 may be configured to implement and/or control a plurality of services and/or microservices, where each of the plurality of services/microservices are configured to execute a plurality of workflows associated with performing the disclosed network management. Non-limiting embodiments of such workflows are provided below in relation to at least FIG. 3.

According to some embodiments, as discussed above, service center engine 200 may function as an application provided by cloud system 106. In some embodiments, engine 200 may function as an application installed on a server(s), network location and/or other type of network resource associated with system 106. In some embodiments, engine 200 may function as an application installed and/or executing on UE 102. In some embodiments, such application may be a web-based application accessed by UE 102. In some embodiments, engine 200 may be configured and/or installed as an augmenting script, program or application (e.g., a plug-in or extension) to another application or program provided by cloud system 106 and/or executing on UE 102.

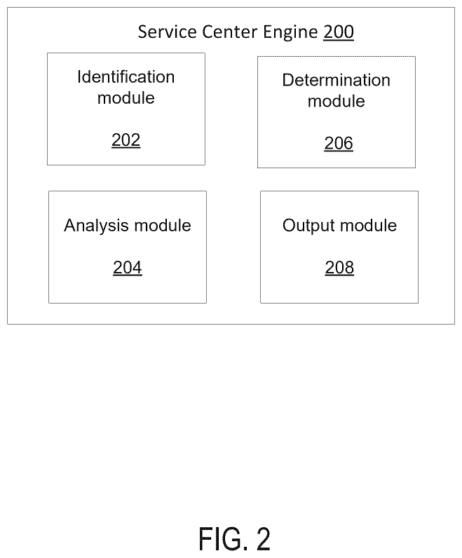

As illustrated in FIG. 2, according to some embodiments, service center engine 200 includes identification module 202, analysis module 204, determination module 206 and output module 208. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below.

Turning to FIG. 3, Process 300 provides non-limiting example embodiments for performing the service request/call management and resultant actions based therefrom. According to some embodiments, the disclosed systems and methods can proactively adapt to shortcomings in existing service call user experiences so as to provide a fail-safe for users in order to ensure their intent is properly identified, and properly and efficiently addressed. Thus, as provided below, according to some embodiments, the disclosed framework can dynamically and automatically analyze user interactions with service agents, whereby user and agent scores can be identified, which can be leveraged for future calls and/or to perform redemptive measures for the service call.

In some embodiments, as discussed below, a customer (or user) cramming score can be utilized to assess the experience of the user, which can further indicate “pain points” related to how difficult the company and/or agent made the service experience. In some embodiments, as discussed below, an agent cramming score can be used to assess the quality and performance of the agent in reducing the “pain points” and addressing the requests of the user.

In some embodiments, as discussed in detail below, the user and/or agent scores can involve variables related to “customer satisfaction”, “agent quality” and “issue resolution quality.” The variables can be compiled and/or determined based on data extracted, retrieved, determined or otherwise identified from specific databases (e.g., database 108, as discussed supra) and/or from the information communicated from the current/real-time occurring service call, as discussed below. Thus, the disclosed systems and methods can provide a generative service call experience that can improve agent performance while reducing the strain on user experience, both during and/or after service calls.

According to some embodiments, Steps 302 and 322 of Process 300 can be performed by identification module 202 of service center engine 200; Steps 304, 310 and 316 can be performed by analysis module 204; Steps 306, 308, 312 and 318 can be performed by determination module 206; and Steps 314 and 320 can be performed by output module 208.

According to some embodiments, Process 300 begins with Step 302 where a service call is received from a user. As discussed above, the service call can be any type of communication form in which a customer can contact and/or engage with a customer service representative/agent. For purposes of the discussion of Process 300, the service call can take the form of a telephone call; however, it should be understood that the service call can take the form of, but not be limited to, a chat, email, form submission, and the like, without departing from the scope of the instant disclosure. Thus, in some embodiments, Step 302 can involve engine 200 connecting a customer service telephone call between a user and a service agent.

In Step 304, the information exchanged during the service call between the user and the agent can be monitored, which can be analyzed by engine 200. According to some embodiments, such analysis can be performed during the call and/or at the conclusion of the call, whereby the data/metadata from the call can be collected, pooled and provided to engine 200 for analysis of such information. In some embodiments, in relation to an analysis during the call and/or after the call, the analysis can be in relation to detected keywords, whereby data/metadata in the information from the service call can provide an indicator as to a type of analysis to be performed. For example, if a streaming service is mentioned, the interaction information between the user and agent can be analyzed to determine the manner in which the service was discussed (e.g., the user requested the streaming service or the agent initiated the discussion).

In some embodiments, such analysis can involve natural language processing (NLP) and/or large language model (LLM) processing, in which voice-to-text data can be collected, for which engine 200 can perform the determinations in Steps 306 and 308, discussed below.

In Step 306, engine 200 can determine an intent of the user related to the service call. In some embodiments, as discussed above, such intent can correspond to the reasoning for which the call was registered by the user. For example, the user called to dispute a bill. In another example, the user called to request an account upgrade/downgrade of service. In yet another example, the user called to troubleshoot their service. And, in another example, the user called to sign up for new functionality (e.g., sign up for Hulu® services/subscription/account).

Thus, in some embodiments, engine 200 can perform a computational analysis of the data/metadata collected during the service call (from Step 304), and determine the user's intent, as in Step 306. In some embodiments, engine 200 may include a specific trained artificial intelligence/machine learning model (AI/ML), a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, engine 200 may be configured to utilize one or more AI/ML techniques selected from, but not limited to, computer vision, feature vector analysis, decision trees, boosting, support-vector machines, neural networks, nearest neighbor algorithms, Naive Bayes, bagging, random forests, logistic regression, and the like. By way of a non-limiting example, engine 200 can implement an XGBoost algorithm for regression and/or classification to analyze the collected information, as discussed herein.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model,
b. transfer the input data to the neural network model,
c. train the model incrementally,
d. determine the accuracy for a specific number of timesteps,
e. apply the trained model to process the newly-received input data,
f. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

In Step 308, engine 200 can determine responsiveness of the agent to the user's intent, which can be performed in a similar manner as discussed above respective to Step 306. According to some embodiments, responsiveness can provide an indication as to whether the information exchanged from the standpoint of the agent correlated, at least to a threshold level of similarity, to the determined intent, as in Step 306. According to some embodiments, Step 308 can therefore involve determining the output of the agent, which can (and/or should have) a contextual relation to the input of the user's intent. Accordingly, the determination in Step 308 can be performed via the AI/ML analysis discussed above in relation to Step 306.

According to some embodiments, the responsiveness determined in Step 308 can be based on the information collected during the current call (as in Step 304); and in some embodiments, the responsiveness can additionally be based on historical data derived from an agent database. Thus, in some embodiments, the responsiveness can be based, at least in part, on an analysis of information related to, but not limited to, an agent repeat call history, agent sentiment history, agent cramming history, incentives of the agent, and the like, or some combination thereof. Similarly, the intent determined in Step 306 can be based on historical data for the user and/or similar events from a customer and/or event database.

In Step 310, engine 200 can analyze the responsiveness of the agent (from Step 308) based on the intent of the user (from Step 306). This, therefore, provides a basis for determining how and/or whether the agent addressed the concerns of the user—for example, did the agent provide the remedies (e.g., solutions and/or answers) to the user's questions about their bill; did the agent properly allocate a new service to the user's account (e.g., did the user request the service upgrade or not), and the like.

Accordingly, in some embodiments, information related to the responsiveness of the agent and the intent of the user can be fed/input to engine 200, which is executing at least one of the AI/ML models discussed above, such that, as in Step 312, a set of scores for the service call can be determined (or computed).

In some embodiments, the analysis and determination in Steps 310-312 can involve determining a type of score, and upon such type determination, performing such scoring compilation for the type or types. For example, if based on the analysis of the responsiveness to the user's intent, it is determined that the agent is “cramming”; then, engine 200 can determine a cramming score for the agent, which can be a score that is specific to the agent and/or the service call (from Step 302). In another example, if the user is subject to “slamming” by the agent (e.g., the user is illegally switched to another service without authorization), then a slamming score can be determined for the agent and/or service call.

In some embodiments, certain types of scores, for certain types of events can be weighted. For example, if an agent has a history (from an agent database) of cramming on service calls, and cramming is detected, then such cramming can be weighted a value to indicate a severity and/or likelihood of its occurrence via the value of the score upon such weighting.

In Step 314, engine 200 can cause the storage of the determined scores in database 108, as discussed above. In some embodiments, such storage can be based on, but not limited to, a type of score, value of the score, user account, event type, agent identifier (ID), agent type (e.g., supervisory versus service agent), and the like, or some combination thereof. As discussed below, such storage can enable further training of the AI/ML models being deployed by engine 200.

In Step 316, the determined set of scores can be analyzed, which can be performed in accordance with a scoring threshold. In some embodiments, the scoring threshold can be based on, but not limited to, a type of agent, type of score, value of weighting (if any), type of event (or service call), and the like, or some combination thereof.

Accordingly, in Step 318, engine 200 can determine whether functionality/capabilities identified in the service call were addressed. For example, did the agent help or perform actions to address their concerns (e.g., upgrade service, reduce bill, understand bill, sign up for new account, and the like). In some embodiments, if the set of scores is below the scoring threshold, then Step 318 can result in a determination that the agent was successful in addressing the user's requests, and processing can proceed to Step 320. In Step 320, engine 200 can cause the record for the service call to be stored in database 108, as discussed above, which can include information derived, determined, generated or otherwise identified from the steps of Process 300 related to the event, agent and/or user. Accordingly, an account of the user can be modified, which can correspond to actions by the agent addressing the user's intent (e.g., fixed the bill, added a requested service/subscription, upgrade/downgrade service, and the like).

In some embodiments, such stored information can be utilized to train and/or further train the AI/ML models implemented by engine 200 so as to improve engine 200's accuracy and efficiency in managing service requests calls.

In some embodiments, when the set of scores are determined to be at or above the scoring threshold, processing can proceed to Step 322, where, in some embodiments, engine 200 can cause the service call to be transferred to another agent. In some embodiments, the selected other agent can be, but is not limited to, a supervisor and/or an agent with a history of having behaviors not related to cramming, slamming, and the like (e.g., not related to the type of scoring which triggered the scoring threshold to be satisfied). Thus, processing for the new agent's interactions and responsiveness to the user and/or service call can recursively proceed back to Step 304, as indicated in FIG. 3.

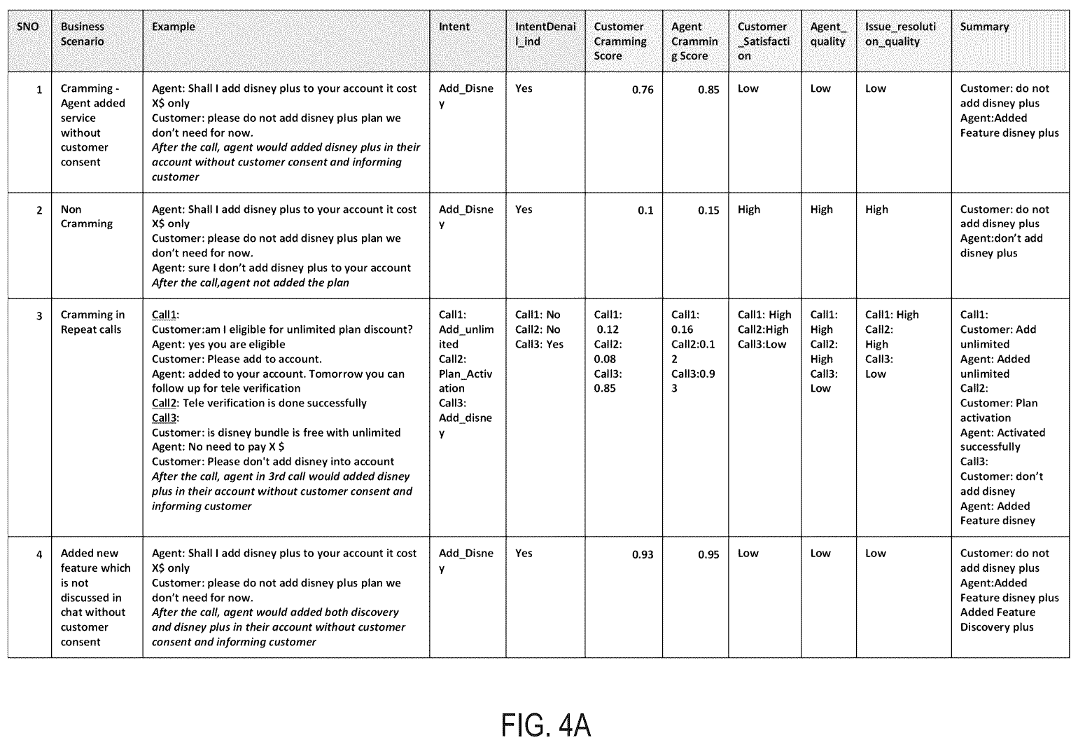

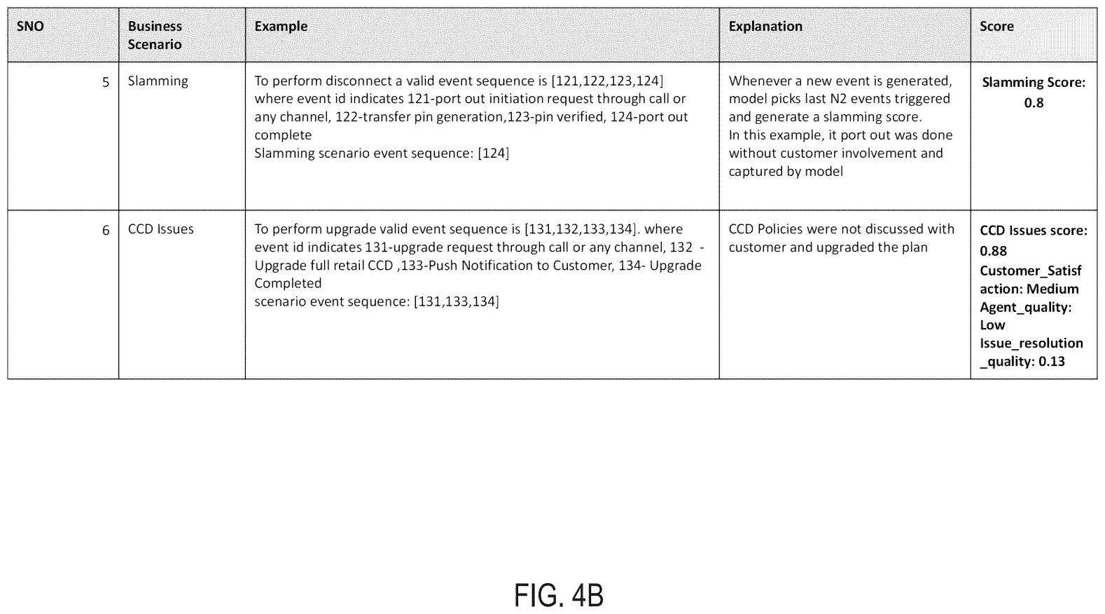

Turning to FIGS. 4A and 4B, depicted are non-limiting examples of determinations, scoring and/or agent classifications from respective service calls/events, as discussed herein. As illustrated in FIGS. 4A and 4B, information related to occurrences of agent cramming, non-cramming and cramming, as well as the addition of unwanted features, slamming and CCD issues from calls are shown, which are depicted to correlate to the user's intent of a service call, as well as data/metadata related to agent responsiveness and the result of the service call.

FIG. 5 is a block diagram of an example network architecture according to some embodiments of the present disclosure. In the illustrated embodiment, UE 102 accesses a data network 508 via an access network 504 and a core network 506.

In the illustrated embodiment, the access network 504 comprises a network allowing network communication with UE 102. In general, the access network 504 includes at least one base station that is communicatively coupled to the core network 506 and coupled to zero or more UE 102.

In some embodiments, the access network 504 comprises a cellular access network, for example, a 5G network. In an embodiment, the access network 504 can include a NextGen Radio Access Network (NG-RAN). In an embodiment, the access network 504 includes a plurality of next Generation Node B (e.g., eNodeB and gNodeB) base stations connected to UE 102 via an air interface. In one embodiment, the air interface comprises a New Radio (NR) air interface. For example, in a 5G network, individual user devices can be communicatively coupled via an X2 interface.

In the illustrated embodiment, the access network 504 provides access to a core network 506 to UE 102. In the illustrated embodiment, the core network may be owned and/or operated by a network operator (NO) and provides wireless connectivity to UE 102. In the illustrated embodiment, this connectivity may comprise voice and data services.

At a high-level, the core network 506 may include a user plane and a control plane. In one embodiment, the control plane comprises network elements and communications interfaces to allow for the management of user connections and sessions. By contrast, the user plane may comprise network elements and communications interfaces to transmit user data from UE 102 to elements of the core network 506 and to external network-attached elements in a data network 508 such as the Internet.

In the illustrated embodiment, the access network 504 and the core network 506 are operated by a NO. However, in some embodiments, the networks (504, 506) may be operated by a private entity and may be closed to public traffic. For example, the components of the network 506 may be provided as a single device, and the access network 504 may comprise a small form-factor base station. In these embodiments, the operator of the device can simulate a cellular network, and UE 102 can connect to this network similar to connecting to a national or regional network.

In some embodiments, the access network 504, core network 506 and data network 508 can be configured as a multi-access edge computing (MEC) network, where MEC or edge nodes are embodied as each UE 102 and are situated at the edge of a cellular network, for example, in a cellular base station or equivalent location. In general, the MEC or edge nodes may comprise UEs that comprise any computing device capable of responding to network requests from another UE 102 (referred to generally for example as a client) and is not intended to be limited to a specific hardware or software configuration of a device.

FIG. 6 is a block diagram illustrating a computing device showing an example of a client or server device used in the various embodiments of the disclosure.

The computing device 600 may include more or fewer components than those shown in FIG. 6, depending on the deployment or usage of the device 600. For example, a server computing device, such as a rack-mounted server, may not include audio interfaces 652, displays 654, keypads 656, illuminators 658, haptic interfaces 662, GPS receivers 664, or cameras/sensors 666. Some devices may include additional components not shown, such as graphics processing unit (GPU) devices, cryptographic co-processors, artificial intelligence (AI) accelerators, or other peripheral devices.

As shown in FIG. 6, the device 600 includes a CPU 622 in communication with a mass memory 630 via a bus 624. The computing device 600 also includes one or more network interfaces 650, an audio interface 652, a display 654, a keypad 656, an illuminator 658, an input/output interface 660, a haptic interface 662, an optional global positioning systems (GPS) receiver 664 and a camera(s) or other optical, thermal, or electromagnetic sensors 666. Device 600 can include one camera/sensor 666 or a plurality of cameras/sensors 666. The positioning of the camera(s)/sensor(s) 666 on the device 600 can change per device 600 model, per device 600 capabilities, and the like, or some combination thereof.

In some embodiments, the CPU 622 may comprise a general-purpose CPU. The CPU 622 may comprise a single-core or multiple-core CPU. The CPU 622 may comprise a system-on-a-chip (SoC) or a similar embedded system. In some embodiments, a GPU may be used in place of, or in combination with, a CPU 622. Mass memory 630 may comprise a dynamic random-access memory (DRAM) device, a static random-access memory device (SRAM), or a Flash (e.g., NAND Flash) memory device. In some embodiments, mass memory 630 may comprise a combination of such memory types. In one embodiment, the bus 624 may comprise a Peripheral Component Interconnect Express (PCIe) bus. In some embodiments, the bus 624 may comprise multiple busses instead of a single bus.

Mass memory 630 illustrates another example of computer storage media for the storage of information such as computer-readable instructions, data structures, program modules, or other data. Mass memory 630 stores a basic input/output system (“BIOS”) 640 for controlling the low-level operation of the computing device 600. The mass memory also stores an operating system 641 for controlling the operation of the computing device 600.

Applications 642 may include computer-executable instructions which, when executed by the computing device 600, perform any of the methods (or portions of the methods) described previously in the description of the preceding Figures. In some embodiments, the software or programs implementing the method embodiments can be read from a hard disk drive (not illustrated) and temporarily stored in RAM 632 by CPU 622. CPU 622 may then read the software or data from RAM 632, process them, and store them to RAM 632 again.

The computing device 600 may optionally communicate with a base station (not shown) or directly with another computing device. Network interface 650 is sometimes known as a transceiver, transceiving device, or network interface card (NIC).

The audio interface 652 produces and receives audio signals such as the sound of a human voice. For example, the audio interface 652 may be coupled to a speaker and microphone (not shown) to enable telecommunication with others or generate an audio acknowledgment for some action. Display 654 may be a liquid crystal display (LCD), gas plasma, light-emitting diode (LED), or any other type of display used with a computing device. Display 654 may also include a touch-sensitive screen arranged to receive input from an object such as a stylus or a digit from a human hand.

Keypad 656 may comprise any input device arranged to receive input from a user. Illuminator 658 may provide a status indication or provide light.

The computing device 600 also comprises an input/output interface 660 for communicating with external devices, using communication technologies, such as USB, infrared, Bluetooth™, or the like. The haptic interface 662 provides tactile feedback to a user of the client device.

The optional GPS transceiver 664 can determine the physical coordinates of the computing device 600 on the surface of the Earth, which typically outputs a location as latitude and longitude values. GPS transceiver 664 can also employ other geo-positioning mechanisms, including, but not limited to, triangulation, assisted GPS (AGPS), E-OTD, CI, SAI, ETA, BSS, or the like, to further determine the physical location of the computing device 600 on the surface of the Earth. In one embodiment, however, the computing device 600 may communicate through other components, providing other information that may be employed to determine a physical location of the device, including, for example, a MAC address, IP address, or the like.

The present disclosure has been described with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in some embodiments” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure has been described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure, a non-transitory computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

To the extent the aforementioned implementations collect, store, or employ personal information of individuals, groups, or other entities, it should be understood that such information shall be used in accordance with all applicable laws concerning the protection of personal information. Additionally, the collection, storage, and use of such information can be subject to the consent of the individual to such activity, for example, through well known “opt-in” or “opt-out” processes as can be appropriate for the situation and type of information. Storage and use of personal information can be in an appropriately secure manner reflective of the type of information, for example, through various access control, encryption, and anonymization techniques (for especially sensitive information).

In the preceding specification, various example embodiments have been described with reference to the accompanying drawings. However, it will be evident that various modifications and changes may be made thereto, and additional embodiments may be implemented without departing from the broader scope of the disclosed embodiments as set forth in the claims that follow. The specification and drawings are accordingly to be regarded in an illustrative rather than restrictive sense.

What is claimed is:

1. A method comprising:
analyzing, by a device, information related to a service request between a user and an agent of a service provider, the service request information comprising data related to interactions between the user and agent;
determining, by the device, based on the analysis, an intent of the user and a responsiveness by the agent, the intent comprising data related to functionality provided by the service provider, the responsiveness comprising data indicating mechanisms employed by the agent related to the intent;
determining, by the device, based on the determined intent and responsiveness, a score for the service request, the score being a type of score that corresponds to the responsiveness data;
determining, by the device, whether the intent of the user was addressed during the service request based on the determined score; and
controlling, by the device, a result of the service request based on the determination of whether the intent was addressed, the control of the result corresponding to capabilities related to the functionality provided by the service provider.

2. The method of claim 1, wherein the control of the result comprises transferring the service request to another agent, wherein the transfer enables further interaction data to be generated and analyzed.

3. The method of claim 1, wherein the result comprises a modification of an account of the user with the service provider.

4. The method of claim 1, further comprising:
analyzing the determined responsiveness based on the determined intent; and
determining the score based on the analysis of the determined responsiveness.

5. The method of claim 4, further comprising:
determining the type of the score for the service request based on the analysis of the determined responsiveness, wherein the type of score corresponds to the interactions data between the user and the agent.

6. The method of claim 1, further comprising:
retrieving, from a database, information related to the user, the user information comprising historical data related to activities of the user; and
retrieving, from the database, information related to the agent, the agent information comprising historical data related to activities of the agent.

7. The method of claim 6, wherein the determination of the intent of the user and the responsiveness of the agent are respectfully based on the user information and agent information.

8. The method of claim 6, wherein the database from which the user information is retrieved is a user database.

9. The method of claim 6, wherein the database from which the agent information is retrieved is an agent database.

10. The method of claim 1, wherein the interactions data comprises an indication of the result of the service request, the result comprising an action performed on behalf of the service provider in response to the intent of the user.

11. A device comprising:
a processor configured to:
analyze information related to a service request between a user and an agent of a service provider, the service request information comprising data related to interactions between the user and agent;
determine, based on the analysis, an intent of the user and a responsiveness by the agent, the intent comprising data related to functionality provided by the service provider, the responsiveness comprising data indicating mechanisms employed by the agent related to the intent;
determine, based on the determined intent and responsiveness, a score for the service request, the score being a type of score that corresponds to the responsiveness data;
determine whether the intent of the user was addressed during the service request based on the determined score; and
control a result of the service request based on the determination of whether the intent was addressed, the control of the result corresponding to capabilities related to the functionality provided by the service provider.

12. The device of claim 11, wherein the control of the result comprises transferring the service request to another agent, wherein the transfer enables further interaction data to be generated and analyzed.

13. The device of claim 11, wherein the result comprises a modification of an account of the user with the service provider.

14. The device of claim 11, wherein the processor is further configured to:
analyze the determined responsiveness based on the determined intent;
determine the type of the score for the service request based on the analysis of the determined responsiveness, wherein the type of score corresponds to the interactions data between the user and the agent; and
determine the score based on the analysis of the determined responsiveness.

15. The device of claim 11, wherein the processor is further configured to:
retrieve, from a database, information related to the user, the user information comprising historical data related to activities of the user; and
retrieve, from the database, information related to the agent, the agent information comprising historical data related to activities of the agent,
wherein the determination of the intent of the user and the responsiveness of the agent are respectfully based on the user information and agent information.

16. A non-transitory computer-readable storage medium storing instructions, executable by a device, wherein the instructions are configured to:
analyzing, by the device, information related to a service request between a user and an agent of a service provider, the service request information comprising data related to interactions between the user and agent;
determining, by the device, based on the analysis, an intent of the user and a responsiveness by the agent, the intent comprising data related to functionality provided by the service provider, the responsiveness comprising data indicating mechanisms employed by the agent related to the intent;
determining, by the device, based on the determined intent and responsiveness, a score for the service request, the score being a type of score that corresponds to the responsiveness data;
determining, by the device, whether the intent of the user was addressed during the service request based on the determined score; and
controlling, by the device, a result of the service request based on the determination of whether the intent was addressed, the control of the result corresponding to capabilities related to the functionality provided by the service provider.

17. The non-transitory computer-readable storage medium of claim 16, wherein the control of the result comprises transferring the service request to another agent, wherein the transfer enables further interaction data to be generated and analyzed.

18. The non-transitory computer-readable storage medium of claim 16, wherein the result comprises a modification of an account of the user with the service provider.

19. The non-transitory computer-readable storage medium of claim 16, further comprising:
analyzing the determined responsiveness based on the determined intent;
determining the type of the score for the service request based on the analysis of the determined responsiveness, wherein the type of score corresponds to the interactions data between the user and the agent; and
determining the score based on the analysis of the determined responsiveness.

20. The non-transitory computer-readable storage medium of claim 16, further comprising:
retrieving, from a database, information related to the user, the user information comprising historical data related to activities of the user; and
retrieving, from the database, information related to the agent, the agent information comprising historical data related to activities of the agent,
wherein the determination of the intent of the user and the responsiveness of the agent are respectfully based on the user information and agent information.
